(19) United States
(12) Patent Application Publication
(10) Pub. No.: US 2026/0331773 A1
(43) Pub. Date: Oct. 22, 2026

(54) Antenna Systems For Metal Electronic Device Enclosures

(71) Applicant: Google LLC, Mountain View, CA (US)

(72) Inventors: Mingjian Li, Mountain View, CA (US); Pei Li, Milpitas, CA (US)

(73) Assignee: Google LLC, Mountain View, CA (US)

(21) Appl. No.: 19/328,738

(22) Filed: Sep. 15, 2025

Related U.S. Application Data
(60) Provisional application No. 63/876,420, filed on Sep. 5, 2025.

(51) Int. Cl. H01Q 5/307; H01Q 3/24; H01Q 5/20

(52) U.S. Cl. CPC H01Q 5/307; H01Q 3/24; H01Q 5/20

(57) ABSTRACT

An antenna system that allows portions of a metal enclosure of an electronic device to function as antenna elements. Different portions of the enclosure can be configured to operate as multiple distinct antenna elements for various wireless communication applications.

### CROSS-REFERENCE TO RELATED APPLICATION

This application claims the benefit of U.S. Provisional Patent Application Ser. No. 63/876,420, filed on Sep. 5, 2025, the disclosure of which is incorporated by reference herein in its entirety.

### BACKGROUND

The integration of antenna systems within wireless communication devices, such as mobile phones, often presents challenges, particularly when considering aesthetic preferences for metal enclosures. A significant problem in current mobile phone designs is the trade-off between achieving a sleek, metal enclosure and maintaining effective antenna performance.

The use of extensive metal surfaces can affect the “keep-out” area for antennas, which can influence signal reception and transmission capabilities. To address this, existing designs may incorporate horizontal antenna splits through the back panel of a metal enclosure. These splits are typically filled with a polymer material that may be visible from the exterior of the device. In some implementations, the horizontal antenna splits are located behind a glass cover on the back of the device. The antenna splits electrically separate portions of the back panel, such as the top and bottom portions, from the main body of the enclosure. While such antenna splits can enable the top and bottom metal portions to function as antenna elements, their placement can involve certain trade-offs. For example, if an antenna element is positioned in the side frame, the width of the radiating arms of the antenna may be limited, which can affect antenna performance. Alternatively, if an antenna element is positioned in the back panel, antenna performance may be different due to increased radiator width. However, this approach can affect the visual continuity of the metal surface, as a horizontal antenna split may be observable on the back of the device, creating a segmented appearance rather than a seamless one. Additionally, these polymer sections can be more susceptible to cosmetic effects, such as scratches and dents, compared to the surrounding metal.

These limitations underscore a continuing need for improved antenna integration solutions that can support multi-band wireless systems within increasingly complex and aesthetically-driven electronic device designs (e.g., mobile device designs).

### SUMMARY

This disclosure provides a solution to the challenge of balancing the aesthetic appeal of a full metal electronic device enclosure with the need for high-performance antennas. The described systems and techniques integrate antenna functionality around a camera bar on the back of the device, which can create a seamless, uninterrupted metal appearance while still achieving robust wireless communication capabilities.

The described antenna systems may enable the use of a continuous, aesthetically seamless metal back panel in electronic devices while maintaining and/or enhancing antenna performance. The systems can provide for wider radiating elements compared to some other designs, which can contribute to radio frequency performance.

The architecture allows portions of the metal enclosure to function as antenna elements. The separation of an upper enclosure portion from a lower enclosure portion is established by a bar split, which may be formed within a channel that extends around a camera bar. This configuration can facilitate improved antenna efficiency by utilizing broader metal surfaces as radiating elements. The different portions of the enclosure can be configured to operate as multiple distinct antenna elements for various wireless communication applications. The camera bar can be mechanically floated relative to the back panel, further contributing to the design's flexibility and performance. In some aspects, the antenna systems provide robust multi-band support and tunability.

This Summary is provided to introduce simplified concepts of antenna systems for metal electronic device enclosures, which are further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of antenna systems for metal electronic device enclosures are described in this document with reference to the following drawings. The use of same numbers in different instances may indicate similar features or components. Series 100 numbers may refer to features originally found in FIG. 1, series 200 numbers may refer to features originally found in FIG. 2, and so on.

FIG. 1 is an illustration of an example implementation of an antenna system of an electronic device.

FIG. 2 is an illustration of an example implementation of an electronic device.

FIG. 3A is a first partial rear view of an example implementation of an electronic device.

FIG. 3B is a second rear view of the electronic device of FIG. 3A.

FIG. 3C is an expanded view of the electronic device shown in the second rear view of FIG. 3B.

FIG. 4A is a first partial perspective view of an example implementation of an electronic device.

FIG. 4B is a second partial perspective view of the electronic device of FIG. 4A.

FIG. 4C is a partial rear view of the electronic device of FIG. 4A, illustrating various antenna portions and splits.

FIG. 5 is a partial rear view an example implementation of an electronic device.

### DETAILED DESCRIPTION

### Overview

The disclosed antenna systems for metal electronic device enclosures address persistent challenges associated with integrating antenna systems into modern wireless communication devices, particularly those featuring metal enclosures, such as mobile phones. A significant problem in existing designs is the compromise between achieving a sleek, full-metal aesthetic and maintaining effective antenna performance. Prior approaches often rely on visible antenna splits (also referred to as “antenna slits” or “antenna breaks”) that are formed in metal housing enclosures. These antenna splits divide the metal back panel into multiple portions to function as separate antenna elements for use by multiple antennas. However, such configurations can lead to degraded antenna performance due to narrow radiating arms or can introduce undesirable aesthetic elements, namely the appearance of long antenna splits on the exterior of the device.

The disclosed techniques and apparatuses involve a novel antenna system that strategically incorporates multiple antennas in a metal upper enclosure portion of an outer enclosure. This configuration may allow for the elimination of conspicuous antenna splits on the exterior of the device while enhancing antenna performance. In some aspects, by creating a channel within the back panel and around a camera bar of the back panel, and by utilizing segmented portions of the upper enclosure portion and/or the lower enclosure portion as antenna elements, the approach aims to overcome the limitations of traditional designs, offering both improved radio frequency (RF) capabilities and a more aesthetically seamless mobile phone form factor.

The disclosed antenna systems for metal electronic device enclosures can mitigate the traditional trade-off between aesthetic design preferences for full metal enclosures and the technical requirements for effective antenna performance. By enabling a metal top back panel without requiring long, visible antenna splits, the approach facilitates a cleaner, more seamless exterior design for wireless communication devices, which can enhance their aesthetic appeal. The design permits the use of wider antenna radiating elements compared to narrow bar splits, which can lead to improved antenna performance in terms of signal reception and transmission. Integrating antennas around the camera bar and leveraging portions of the existing metal back panel efficiently utilizes available space within compact device form factors. Furthermore, the configuration of multiple antenna portions and the utilization of dynamic shorting structures or antenna aperture ports provide flexible support of various frequency bands and wireless communication protocols, which is useful for modern multi-coexistent wireless systems. The strategic sizing of shorting structures and the potential for dynamically controlling their electrical status provides a high degree of tunability, an adaptability that can optimize antenna performance for different applications and operating conditions, allowing for both a seamless metal design and effective antenna performance without significant compromise.

### Metal Device Enclosure and Structural Elements

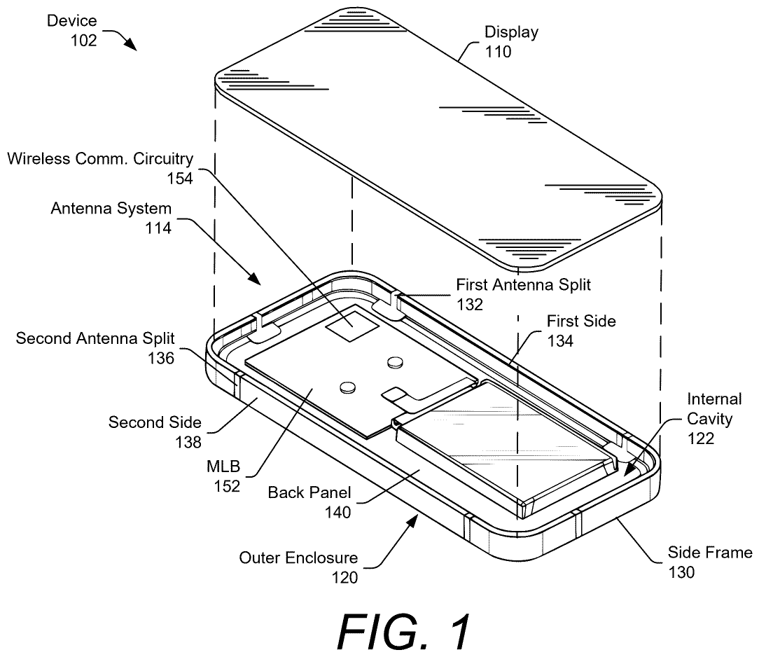

The structural and electrical configurations of the disclosed devices and techniques integrate antenna functionality within a metal device enclosure (e.g., a mobile phone enclosure). FIG. 1 illustrates an example implementation of an electronic device (e.g., a mobile phone). The electronic device 102 includes an outer enclosure and a display 110. The display 110 may be implemented as a display panel stack having a cover layer and a display panel module. The outer enclosure may be formed of an electrically conductive material, for example, a material that is a metal-based material (a metal material, a metallic material). Examples of metal-based materials include aluminum alloy, stainless steel, steel, titanium alloy, magnesium alloy, and the like. In the example aspect illustrated in FIG. 1, the outer enclosure is a metal outer enclosure 120. In some aspects, the metal outer enclosure 120 is substantially rectangular-parallelepiped shaped, having a top end opposite a bottom end and a first side opposite a second side. A back panel 140 is defined in the metal outer enclosure 120. In some aspects, the back cover (e.g., back panel 140) of the electronic device 102 does not include a separate covering or material, for example, the back cover does not include a glass covering (e.g., cover glass covering). A side frame 130 that extends about a periphery (e.g., perimeter) of the back panel 140 to define a side bezel of the electronic device is also defined in the metal outer enclosure 120. The back panel 140 and/or the side frame 130 may include separate portions connected together and/or disconnected from one another.

The metal outer enclosure 120 may be formed from the metal material, for example, by a computer numerical control (CNC) machining process (e.g., by a machine tool, such as a milling cutter). In one example approach, a billet of metal material is placed in a fixture and is CNC machined, by removal of material, to form the metal outer enclosure 120. In some aspects, the side frame 130 and the back panel 140 of the metal outer enclosure 120 may be formed from the same piece of material.

The machining process also may be utilized to form one or more slots in the metal outer enclosure 120. A slot may extend entirely through the metal outer enclosure 120 (e.g., through the metal side frame 130, through the metal back panel 140). For example, a slot may begin on an interior surface of the metallic outer enclosure (e.g., on the side frame 130 and extend toward the back panel 140) and end on an exterior surface (e.g., at the back panel 140). A slot may divide the metal outer enclosure 120 to allow for isolation between multiple antennas of the electronic device. For example, by creating a gap between radiating metal portions of two or more antennas of the electronic device.

The slots may be configured to receive a non-metallic material (e.g., polymer material, non-conductive material, Nano Molding Technology (NMT) material) to form an antenna split (e.g., an antenna split line, a non-metallic region). An antenna split is a non-conductive gap or strip that breaks the continuity of the metal outer enclosure to allow internal antennas to function properly (e.g., by permitting radio frequency (RF) signals to pass through a portion of the metal outer enclosure). An antenna split may be formed in a slot through a suitable process fabrication process, which may include one or more of an overmolding process, an injection-molding process, an insert molding process, an additive manufacturing process (e.g., a fused deposition modeling (FDM) process, a three-dimensional (3D) printing process), or the like.

The antenna split may electrically isolate one metal outer enclosure element from another metal outer enclosure element (e.g., first side frame element associated with a first antenna from an adjacent second side frame element associated with a second antenna). For example, a first antenna split (e.g., first side split 132) on a first side 134 of the side frame 130 may be utilized to electrically isolate a first side frame portion from a top end frame portion and/or a second antenna split (e.g., second side split 136) on the second side 138 of the metal outer enclosure 120 may be utilized to electrically isolate a second side frame portion from the top end frame portion. A side frame portion may include one or more additional antenna splits configured to electrically isolate one or more additional frame portions from the side frame portion. An antenna split may mechanically combine the adjacent (e.g., split-separated) antenna portions, for example, through techniques such as NMT or other suitable bonding, integration technologies, and/or manufacturing processes that maintain mechanical integrity across electrically isolated metal segments. Although FIG. 1 illustrates multiple antenna splits, in various aspects, the metal outer enclosure 120 may include less than or more than the number of antenna splits illustrated.

The metal outer enclosure 120 defines an internal cavity 122, for example, between the side frame 130 and the back panel 140. The internal cavity 122 is configured to receive one or more internal component modules (e.g., a main logic board 152 (MLB 152), wireless communication circuitry 154 for generating antenna signals, a battery, a sensor module, and the like) of the electronic device 102. The wireless communication circuitry 154 (e.g., a radio chipset, an antenna tuning circuit configured to tune an antenna to one of a plurality of frequency bands, a signal generator) can be implemented as part of the main logic board 152 for the electronic device 102.

The electronic device 102 includes an antenna system 114, which in some aspects includes one or more of the metal outer enclosure, the back panel, the side frame, the antenna split(s), the wireless communication circuitry, antenna feeds, aperture tuning ports, and/or ground contacts. The disclosed antenna systems are implemented by using an electrically conductive, metal outer enclosure 120 (e.g., back panel 140) that includes one or more antenna structures (e.g., radiating arms). The antenna structures enable the back panel 140 to act as an antenna element for one or more antennas of the antenna system 114. The antenna structures may be formed as one or more antennas based on one or more of the antenna splits positioned in appropriate locations on the metal outer enclosure, antenna feeds conductively coupled to the wireless communication circuitry, aperture tuning ports conductively coupled to wireless communication circuitry, and/or ground contacts connectively coupled to the metal outer enclosure 120 to connect the metal outer enclosure to other antennas and/or wireless communication circuitry 154. Using the antenna system 114, antenna signals generated and received by the wireless communication circuitry 154 can be electrically routed and injected into the metal back panel 140 sufficient to allow the metal back panel 140 to act as an antenna element for one or more antennas of a wireless communication system.

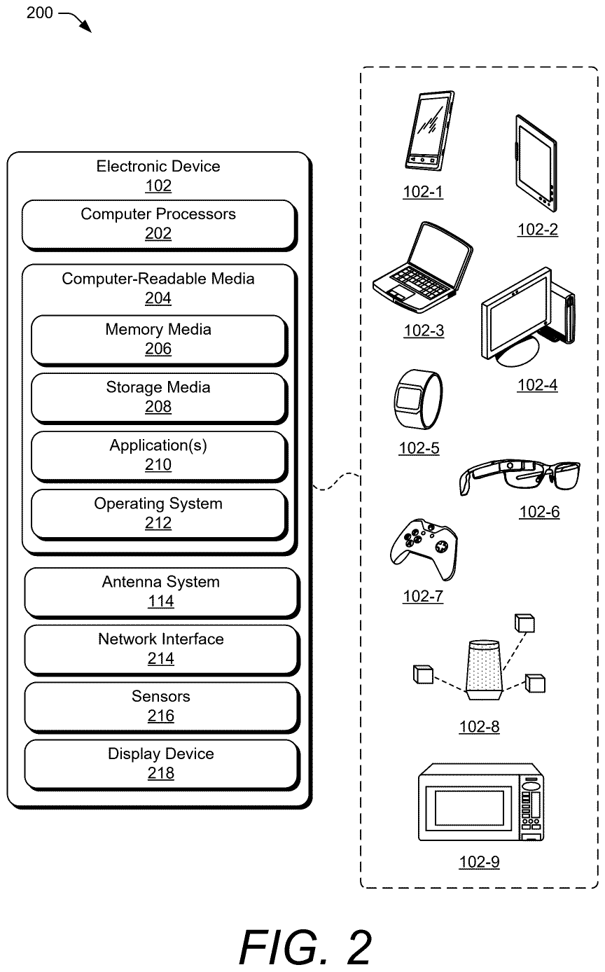

FIG. 2 illustrates an example implementation 200 of the electronic device 102 from FIG. 1 in more detail. The electronic device 102 of FIG. 2 is illustrated with a variety of example devices, including a smartphone 102-1, a tablet 102-2, a laptop 102-3, a desktop computer 102-4, a wearable electronic device (e.g., a computing watch 102-5, computing spectacles 102-6), a gaming system 102-7, a home-automation and control system 102-8, and a microwave 102-9. The electronic device 102 can also include other devices, e.g., televisions, entertainment systems, audio systems, automobiles, drones, track pads, drawing pads, netbooks, e-readers, home security systems, and other home appliances. Note that the electronic device 102 can be mobile, wearable, non-wearable but mobile, or relatively immobile (e.g., desktops, appliances). The electronic device 102 includes one or more computer processors 202 and may include one or more computer-readable media 204. The computer-readable media 204 may include memory media 206 and/or storage media 208. Applications 210 and/or an operating system 212 that are implemented as computer-readable instructions on the computer-readable media 204 can be executed by the computer processors 202 to provide some or all of the functionalities described herein.

The electronic device 102 includes an antenna system 114 that can enable the electronic device 102 to communicate wirelessly with other devices and/or servers over a network using a network interface 214. The network may be any suitable network, some examples of which include a local-area-network (LAN), a wireless local-area-network (WLAN), a personal-area-network (PAN), a wide-area-network (WAN), an intranet, the Internet, a peer-to-peer network, point-to-point network, or a mesh network. Various implementations of the antenna system 114 can include, or communicate with, a System-on-Chip (SoC), one or more Integrated Circuits (ICs), a processor with embedded processor instructions or configured to access processor instructions stored in memory, hardware with embedded firmware, a printed circuit board with various hardware components, or any combination thereof.

The electronic device 102 may also include one or more sensors 216, which can include any of a variety of sensors, including an audio sensor (e.g., a microphone), a touch-input sensor (e.g., a touchscreen, a fingerprint sensor, a capacitive touch sensor), an image-capture device (e.g., a camera), proximity sensors (e.g., capacitive sensors), an ambient light sensor (e.g., photodetector), and the like. The front panel 110 of the electronic device 102 may include a display device 218. The display device 218 can include any suitable touch-sensitive display device, e.g., a touchscreen, a liquid crystal display (LCD), thin film transistor (TFT) LCD, an in-place switching (IPS) LCD, a capacitive touchscreen display, an organic light-emitting diode (OLED) display, an active-matrix organic light-emitting diode (AMOLED) display, super AMOLED display, and so forth.

These and other capabilities and configurations, as well as ways in which entities of FIGS. 1 and 2 act and interact, are set forth in greater detail below. These entities may be further divided, combined, and so on. The electronic device 102 of FIG. 1 and the detailed illustrations of FIGS. 2-5 illustrate some of many possible environments, devices, and methods capable of employing the described apparatuses and techniques, whether individually or in combination with one another.

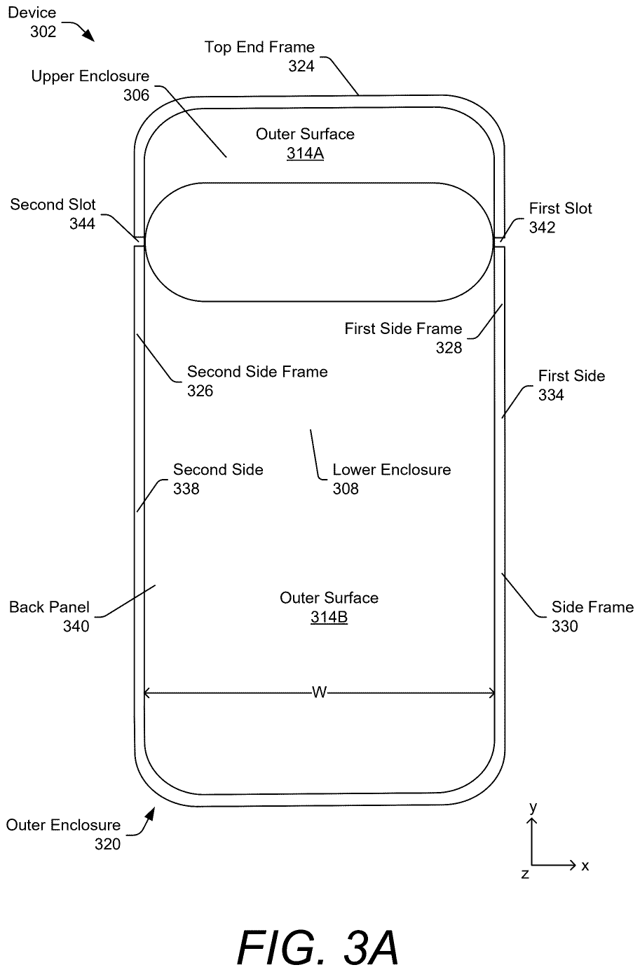

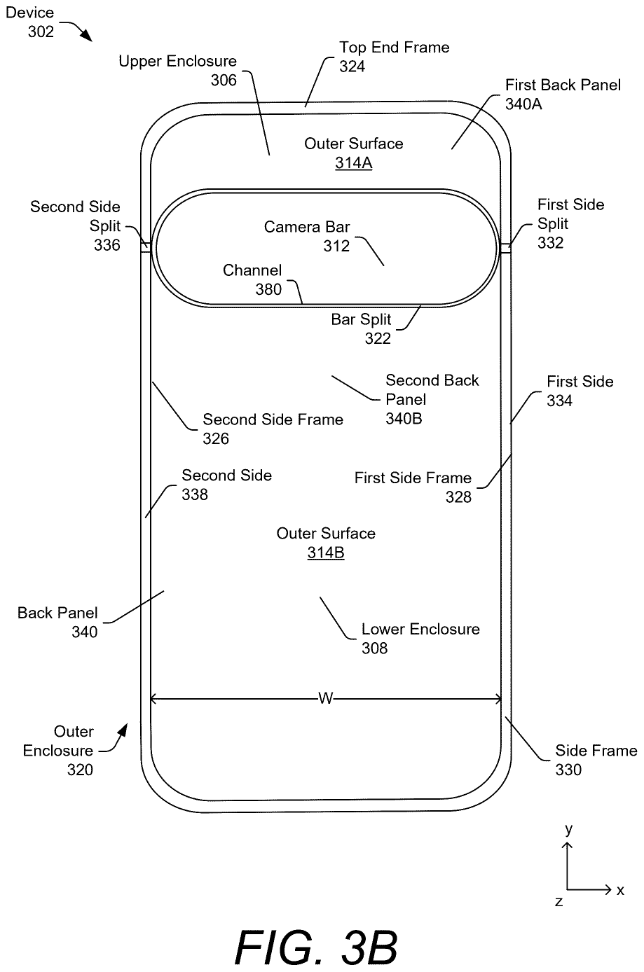

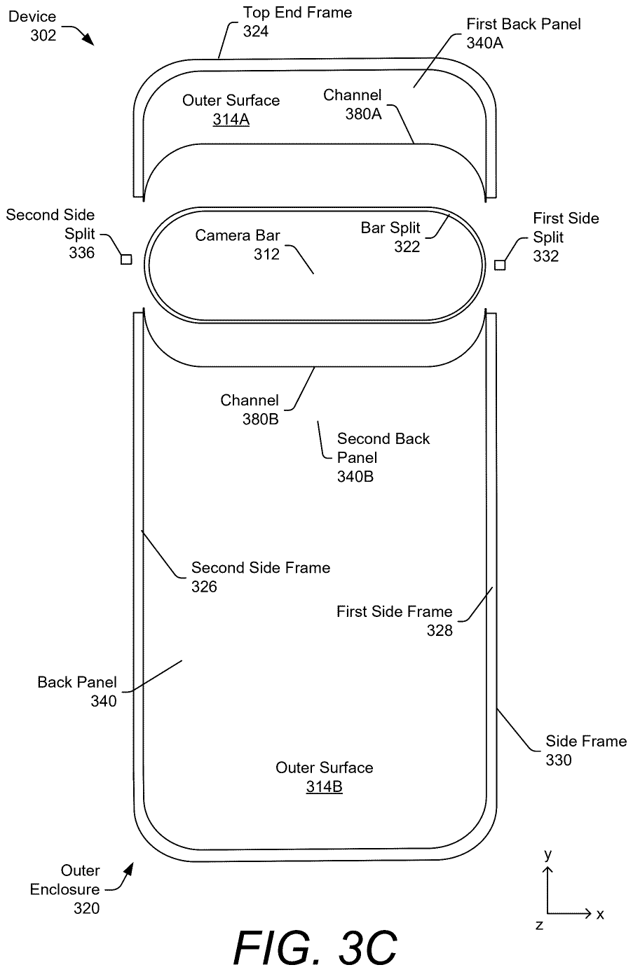

FIGS. 3A, 3B, and 3C are schematic illustrations of an example implementation of an electronic device 302, which is similar to the electronic device 102 illustrated in FIGS. 1 and 2 and described above, except as detailed below. Thus, the electronic device 302 includes an antenna system, an outer enclosure 320, a side frame 330, a first side split 332, a second side split 336, a back panel 340, wireless communication circuitry, and the like. In some aspects, the back cover (e.g., back panel 340) of the electronic device 302 does not include a separate covering or material, for example, the back cover does not include a glass covering (e.g., cover glass covering).

The machining process described above with respect to FIG. 1, may be utilized to form one or more slots in the metal outer enclosure 320. A slot may extend entirely through the metal outer enclosure 320 (e.g., through the metal side frame 330, through the metal back panel 340). A slot may divide the metal outer enclosure 320 to allow for isolation between multiple antennas of the electronic device. For example, by creating a gap between radiating metal portions of two or more antennas of the electronic device. Two slots are illustrated in FIG. 3A, namely first slot 342 on the first side 334 of the side frame 330 and second slot 344 on the second side 338 of the side frame 330.

A top end frame portion 324 is defined between the first slot 342 and the second slot 344. A first side frame portion 328 is defined on the opposite side of the first slot 342 from the top end frame portion 324 and a second side frame portion 326 is defined on the opposite side of the second slot 344 from the top end frame portion 324. In the aspect illustrated in FIGS. 3A-3C, the first side frame portion 328 and the second side frame portion 326 are effectively the same side frame portion. In other aspects, at least one other antenna split may be defined between first and second side frame portions. In FIGS. 3B and 3C, the first slot 342 includes first side split 332 and the second slot 344 includes second side split 336. The side splits (first side split 332, second side split 336) are not illustrated in FIG. 3A. The antenna splits electrically isolate a first side frame portion 328 from the top end frame portion 324 and/or the second side frame portion 326 from the top end frame portion 324.

The electronic device 302 includes a camera bar 312 located on a rear portion of the outer enclosure 320. The camera bar 312 may extend in a Z-direction away from the chassis of the back panel 340 (e.g., away from the outer surfaces of the upper enclosure portion 306 and the lower enclosure portion 308). The camera bar 312 may terminate at a surface that is spaced apart from the chassis of the back panel 340. The camera bar 312 may be oriented generally perpendicular to a long axis (e.g., y-axis) of the outer enclosure 320. The camera bar 312 may include at least one sensor 216 (e.g., an optical module of a camera assembly). While the term “camera bar” is used herein, in some aspects the camera bar may not include an optical module of a camera assembly. The camera bar 312 is not illustrated in FIG. 3A.

The camera bar 312 can be configured as a distinct component, which may be formed from a metallic material, and can be integrated into the device enclosure. The camera bar 312 can have a generally elongated or bar-like shape and may span a substantial portion or the full width of the device. Its form may be a solid piece or may include internal structures. For example, the camera bar 312 can be machined from the same block of material as the back panel or from a different metallic material. Variations in shape can include different lengths or widths to accommodate varying camera module sizes or designs. The camera bar may also include an opening configured to receive a camera lens or an array of lenses.

The back panel 340 may include a channel 380 (e.g., a gap) that defines the camera bar 312 from the back panel 340. In some aspects, the channel 380 may be continuous, forming a ring-shaped separation, as illustrated in FIGS. 3A and 3B. In some aspects, the ring-shaped channel is circular, annular, round, elliptical, ovular, loop-shaped, arc-shaped, stadium-shaped (e.g., in the form of a rectangle with semicircles at a pair of opposite sides), or the like. The specific geometry of the channel separating the camera bar from the back panel can vary; it might not be strictly ring-shaped but could adopt other contours or segmented patterns tailored to specific industrial designs or functional requirements. A ring-shaped channel may be utilized to separate the upper enclosure portion 306 from the lower enclosure portion 308 to facilitate the separation of antenna elements on the upper enclosure portion 306 from antenna elements on the lower enclosure portion 308. In other aspects, the channel 380 may be segmented into multiple portions, with the segmentation adapted to accommodate various features or functions within the electronic device.

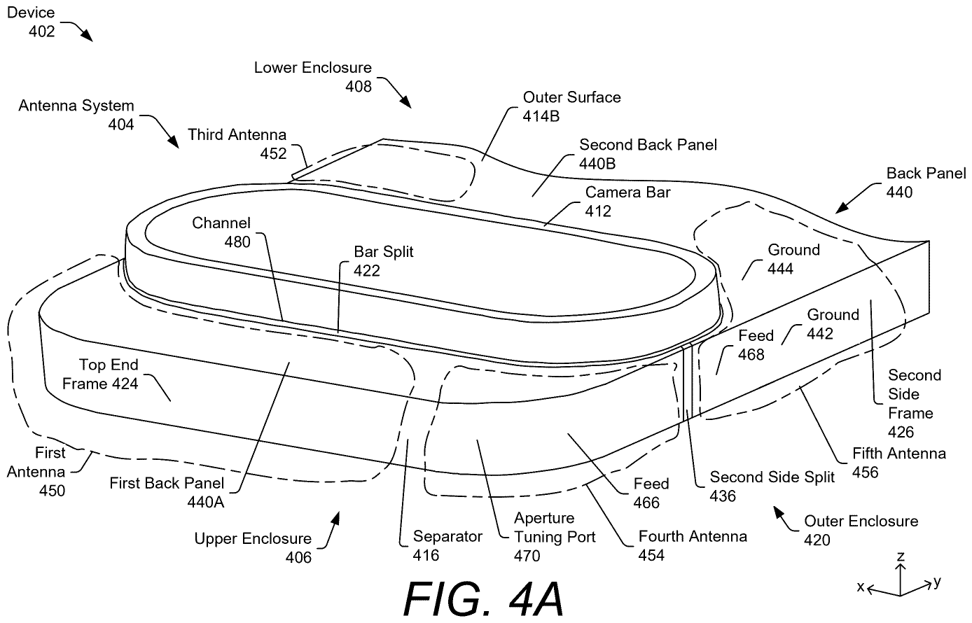

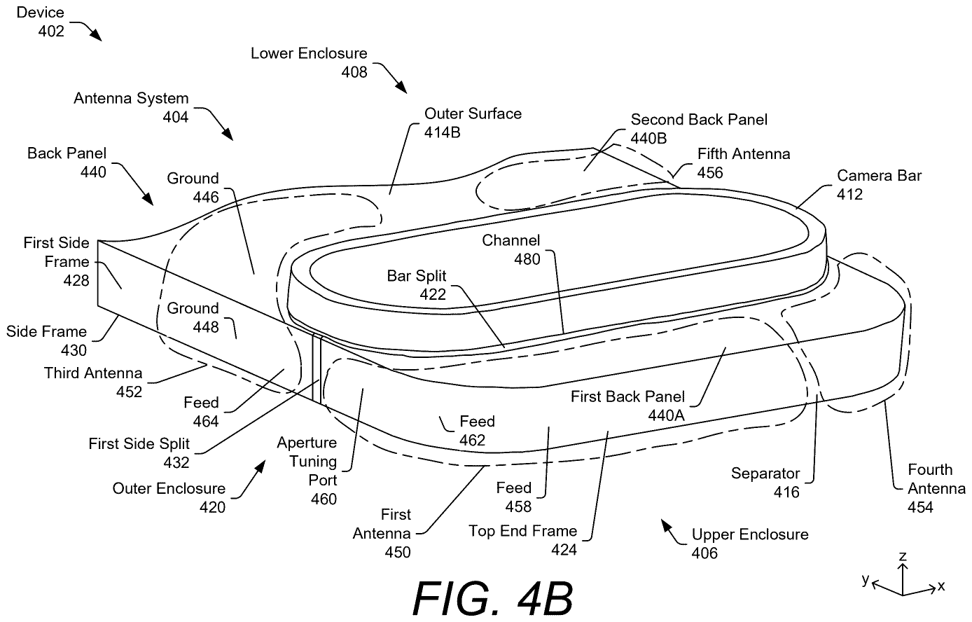

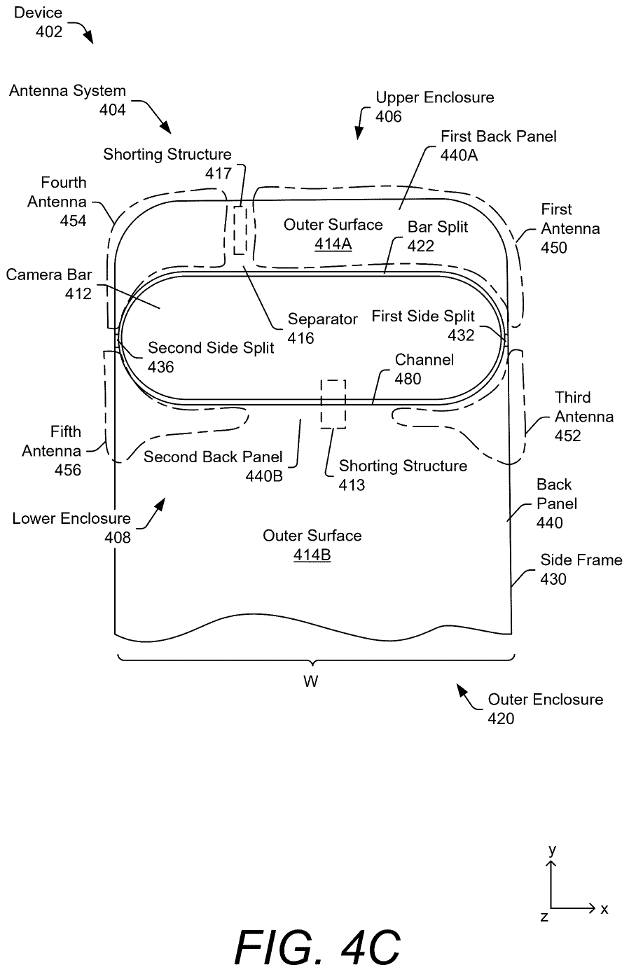

The channel 380 may be formed in the back panel 340 (e.g., by a CNC machining process) and extend entirely through the back panel 340 to electrically isolate the camera bar 312 from the back panel 340. The channel 380 in the back panel 340 may define at least one outer enclosure element configured to allow for isolation between multiple antennas of the electronic device. For example, the channel 380 may define the upper enclosure portion 306 that includes a first back panel portion 340A on a first side of the channel 380 and the top end frame portion 324 and the channel 380 may define a lower enclosure portion 308 that includes a second back panel portion 340B on a second side of the channel 380 and the second side frame portion 326. In such a configuration, the upper enclosure portion 306 and the lower enclosure portion 308 are isolated from one another and are isolated from the camera bar 312 by the channel 380. In some aspects, the channel 380 is defined in the back panel 340 between the upper enclosure portion 306 and the lower enclosure portion 308, as represented by channel 380A and channel 380B in the expanded view of FIG. 3C. The first slot 342, the second slot 344, and the channel 380 may interconnect. In this way, the first side split 332 and the second side split 336 may connect with a bar split 322 to facilitate the separation of antenna elements, as discussed below with respect to FIGS. 4A-4C.

The channel 380 is configured to receive a material (e.g., polymer material, non-conductive material, NMT material) to form another antenna split (e.g., a bar split 322). The bar split 322 may be formed in the channel 380 through a suitable process fabrication process, disclosed herein. Through the bar split 322 in the channel 380, the camera bar 312 is electrically isolated from the back panel 340 (e.g., first back panel portion 340A, second back panel portion 340B), the upper enclosure portion 306, and the lower enclosure portion 308. In this way, the bar split 322 may be utilized to electrically isolate the first back panel portion 340A from the second back panel portion 340B to enable the upper enclosure portion 306 (e.g., first back panel portion 340A) to function as an antenna element for a first antenna (e.g., illustrated as first antenna 450 in FIGS. 4A-4C) and to enable the lower enclosure portion 308 (e.g., second back panel portion 340B) to function as an antenna element for another antenna (e.g., third antenna 452 in FIGS. 4A-4C). In this way, the back panel 340 (e.g., upper enclosure portion 306) may be formed devoid of a visible horizontal antenna split, resulting in a more aesthetically seamless mobile phone form factor.

The camera bar 312 may extend across a substantial portion of a width (W) of the back panel 340, for example, substantially extending from the first side split 332 to the second side split 336, as illustrated in FIGS. 3A-3C. In some aspects, the camera bar 312 may extend across the entire portion of the width of the back panel 340, from the first side split 332 to the second side split 336. It is understood that, unless specified otherwise, the term “substantial portion,” as used herein, refers to a portion of at least about 50%. In some aspects, the substantial portion is at least about 60%, at least about 70%, at least about 75%, at least about 80%, at least about 85%, at least about 88%, at least about 90%, at least about 91%, at least about 92%, at least about 93%, at least about 94%, at least about 95%, at least about 96%, at least about 97%, at least about 98%, or at least about 99%.

The camera bar 312 may be formed from the same piece of material as the metal outer enclosure 320 (e.g., the same piece of material as the side frame 330 and/or the back panel 340) and may be defined in and/or extend outwards from an outside surface 314A of the metal back panel 340 (e.g., from outer surface 314B of the first back panel 340A and/or from the outer surface 314B of the second back panel 340B, as illustrated in FIG. 3C). In various aspects, the camera bar 312 may be separately formed from a separate piece of a metal material and mounted on or otherwise attached to the back panel 340.

Through the antenna systems for metal electronic device enclosures, the back panel 340 can be divided into multiple distinct sections, each capable of being configured as a separate antenna, as discussed below with respect to FIGS. 4A-4C.

### Antenna System Configuration and Integration

FIGS. 4A and 4B are partial perspective views of an example implementation of an electronic device 402, which is similar to the electronic devices illustrated in FIGS. 1-3 and described above, except as detailed below. Thus, the electronic device 402 includes an antenna system 404, an upper enclosure portion 406, a lower enclosure portion 408, a camera bar 412, an outer surface 414A, an outer surface 414B, an outer enclosure 420, a side frame 430, a first antenna split (e.g., first side split 432), a second antenna split (e.g., second side split 436), a back panel 440, wireless communication circuitry, and the like. In some aspects, the back cover (e.g., back panel 440) of the electronic device 402 does not include a separate covering or material, for example, the back cover does not include a glass covering (e.g., cover glass covering). The electronic device 402 is further illustrated in the partial rear view of FIG. 4C.

The outer enclosure 420 includes a first slot and a second slot, which are configured to respectively receive first side split 432 and second side split 436. The first and second slots divide the outer enclosure 420 to allow for isolation between multiple antennas of the electronic device. A top end frame portion 424 is defined between the first and second slots. A second side frame portion 426 is defined on the opposite side of the first slot into which the second side split 436 is formed. A first side frame portion 428 is defined on the opposite side of the second slot into which the first side split 432 is formed.

The camera bar 412 is located on a rear portion of the outer enclosure 420 and may extend in a Z-direction away from the chassis of the back panel 440 (e.g., away from the outer surfaces of the upper enclosure portion 406 and the lower enclosure portion 408). The camera bar 412 may terminate at a surface that is spaced apart from the chassis of the back panel 440. The camera bar 412 may be oriented generally perpendicular to a long axis of the outer enclosure 420 and may include at least one sensor (e.g., an optical module of a camera assembly).

The back panel 440 may include a channel 480 (e.g., a gap) that defines the camera bar 412 from the back panel 440. In some aspects, the channel 480 may be continuous, forming a ring-shaped separation, as illustrated in FIGS. 4A, 4B, and 4C, which facilitates the separation of antenna elements. In other aspects, the channel 480 may be segmented into multiple portions, with the segmentation adapted to accommodate various features or functions within the electronic device. The channel 480 may be formed in the back panel 440 (e.g., by a CNC machining process) and extend entirely through the back panel 440 to electrically isolate the camera bar 412 from the back panel 440.

The channel 480 in the back panel 440 may define at least one outer enclosure element configured to allow for isolation between multiple antennas of the electronic device. For example, the channel 480 may define the upper enclosure portion 406 that includes a first back panel portion 440A on a first side of the channel 480 and a lower enclosure portion 408 that includes a second back panel portion 440B on a second side of the channel 480. In such a configuration, the upper enclosure portion 406 and the lower enclosure portion 408 are isolated from one another and are isolated from the camera bar 412 by the channel 480. In some aspects, the channel 480 is defined in the back panel 440 between the upper enclosure portion 406 and the lower enclosure portion 408, as represented by channel 380A and channel 380B in FIG. 3C.

The channel 480 is configured to receive a material (e.g., polymer material, non-conductive material, NMT material) to form another antenna split (e.g., a bar split 422). The bar split 422 may be formed in the channel 480 through a suitable process fabrication process, disclosed herein. Through the bar split 422 in the channel 480, the camera bar 412 is electrically isolated from the back panel 440 (e.g., first back panel portion 440A, second back panel portion 440B), the upper enclosure portion 406, and the lower enclosure portion 408. In this way, the bar split 422 may be utilized to electrically isolate the first back panel portion 440A from the second back panel portion 440B to enable the upper enclosure portion 406 (e.g., first back panel portion 440A) to function as an antenna element for a first antenna 450 and to enable the lower enclosure portion 408 (e.g., second back panel portion 140B) to function as an antenna element for another antenna (e.g., third antenna 452). In this way, the back panel 440 may be formed devoid of a visible horizontal antenna split, resulting in a more aesthetically seamless mobile phone form factor. The form of an antenna element can be a conductive trace, a patch, or another suitable antenna structure, such as a slot antenna, a monopole antenna, or a planar inverted-F antenna (PIFA), and the like.

The camera bar 412 may extend across a substantial portion of a width (W) of the back panel 440, for example, substantially extending from the first side split 432 to the second side split 436 as illustrated in FIG. 4C. In some aspects, the camera bar 412 may extend across the entire portion of the width of the back panel 440, from the first side split 432 to the second side split 436.

The camera bar 412 may be formed from the same piece of material as the metal outer enclosure 420 (e.g., the same piece of material as the side frame 430 and/or the back panel 440) and may be defined in and/or extend outwards from an outside surface 414 of the metal back panel 440 (e.g., from outer surface 414A of the first back panel 440A and/or from the outer surface 414B of the second back panel 440B, as illustrated in FIG. 4C). In various aspects, the camera bar 412 and/or other portions of the camera assembly may be separately formed from a separate piece of a metal material and mounted on or otherwise attached to the back panel 440.

The camera bar 412 may be electrically grounded to a system ground internally. If the camera bar 412 is grounded, an internal electrical grounding path may connect the camera bar 412 to the system ground through a shorting structure 413. The shorting structure can be utilized while maintaining electrical isolation between the camera bar 412 and the surrounding back panel 440. Examples of shorting structures include one or more of a pin, an electrical through hole, a contact pad, a wall (e.g., a shorting wall), a clip, a spring finger, a via, a Flex-on-Flex (FOF) connector, an internal grommet, or the like. The size and characteristics of the shorting structures can be selected to control antenna performance across different frequency bands. Through shorting structures, separate multiple antenna portions around the camera bar 412 can be defined without utilization of visible, external, horizontal antenna splits on the back panel 440. In other aspects, the camera bar 412 is “floating,” being mechanically connected to the structure but electrically floating by not directly connecting to the system ground of the device.

Through the antenna systems for metal electronic device enclosures, the back panel 440 can be divided into multiple distinct sections, each capable of being configured as a separate antenna. For example, in the aspect illustrated in FIGS. 4A, 4B, and 4C, four antenna portions (first antenna 450, third antenna 452, fourth antenna 454, and fifth antenna 456) are formed from the back panel 440. While four antenna portions are described, the back panel could be divided into more than four portions to support a greater number of antennas or more complex antenna arrays. What is commonly referred to as the “second” antenna, which is typically located on an opposite, bottom end of a metal outer enclosure of a mobile phone, is not labeled in these views.

The size and shape of an antenna element can vary depending on the frequency band it is configured to operate within, and a different configuration may include a single antenna element capable of operating across multiple, disparate frequency bands, achieved through broadband design or frequency reconfigurability. It is contemplated that the antenna elements could be combined in various ways to achieve different functionalities. For instance, first antenna and fourth antenna could be configured as a MIMO (Multiple-Input, Multiple-Output) array for enhanced data throughput, while third antenna and fifth antenna could form a diversity pair for improved signal reception in challenging environments. Alternatively, different antenna elements could be dedicated to specific wireless technologies, such as one for cellular communication, another for Wi-Fi, a third for Bluetooth, and a fourth for GNSS (e.g., global positioning system (GPS)), allowing for simultaneous multi-protocol operation.

The electronic device 402 includes antenna feed ports. For example, in FIGS. 4A and 4B, the first antenna 450 includes antenna feed 462 and antenna feed 458; the third antenna 452 includes antenna feed 464; the fourth antenna 454 includes antenna feed 466; and the fifth antenna 456 includes antenna feed 468. The antennas electrically connect to antenna feed ports for electrical connection with a feed source (e.g., wireless communication circuitry 154) to access antenna signals generated by the feed source. The antenna feed ports may be positioned within the metal outer enclosure 420 proximate to the back panel 440 (e.g., upper enclosure portion 406, lower enclosure portion 408), such that the antenna receives and/or transmits radio-frequency communications through the back panel 440, to enable the back panel 440 can function as a radiating antenna element for one or more antennas of the antenna system 404. Although FIGS. 4A and 4B illustrate antenna feeds in certain positions on the upper enclosure portion 406 and lower enclosure portion 408, in various aspects, the upper enclosure portion 406 and/or lower enclosure portion 408 may include one or more antenna feeds in other positions.

The antenna system of the electronic device 402 may also include an aperture tuning port that is configured to adjust the RF characteristics of the antenna to enable the antenna to resonate and operate efficiently across multiple frequency bands. For example, in FIGS. 4A and 4B, the first antenna 450 includes aperture tuning port 460 and the fourth antenna 454 includes aperture tuning port 470. In implementations, the aperture tuning port 460 may be an aperture tuning port for mid band (MB), high-band (HB), and/or ultra-high band (UHB) frequencies and/or the aperture tuning port 470 may be an aperture tuning port for low-band (LB) frequencies. Although FIGS. 4A and 4B illustrate aperture tuning ports in certain positions on the upper enclosure portion 406, in various aspects, the antennas disposed within the upper enclosure portion 406 and/or lower enclosure portion 408 may include one or more aperture tuning ports in other positions.

The electronic device 402 includes one or more ground contacts. For example, ground contact 442, ground contact 444, ground contact 446, and ground contact 448, illustrated in FIGS. 4A and 4B. Multiple (e.g., a series of) ground contacts may be used to define the size of the internal radiator for an antenna. In some aspects, a series of grounds are utilized, which help to isolate a corner of the metal outer enclosure (e.g., a corner of the first back panel portion 440A, a corner of the second back panel portion 440B, a corner of the side frame 430, a corner between a back panel portion and the side frame, and the like). In such a configuration, an antenna feed (e.g., a side antenna feed) may excite the corner of the metal outer enclosure with a non-corner portion of the metal outer enclosure isolated by grounding to enable the back panel 440 to function as a radiating antenna element for one or more antennas of the antenna system 404. Although FIGS. 4A and 4B illustrate multiple ground contacts in certain positions on the second back panel portion 440B, in various aspects, the metal outer enclosure 420 may include ground contacts in other positions.

At a separator 416, grounding and/or RF reactive loading can be utilized to separate the first antenna 450 and the fourth antenna 454. For example, reactive loading may be performed (e.g., by adding a capacitor or other capacitive loading device to the antenna) to “shorten” at least one of the first or fourth antennas to accommodate both of the first and fourth antennas on the upper enclosure portion 406. In some aspects, another separator (not illustrated) may be utilized to separate the third antenna 452 and the fifth antenna 456. In some aspects, the separator 416 may not be utilized, thereby configuring a substantial portion of the upper enclosure portion 406 to be excited for low-band (LB) frequencies, which need a larger radiator. For mid-band (MB) and high-band (HB) frequencies, the separator 416 of the upper enclosure portion 406 may act as reactive loading or as a short. In this way, by controlling the ground, the upper enclosure portion 406 can be separated into a left portion (fourth antenna) and a right portion (first antenna). In HB frequencies, the separator 416 of the upper enclosure portion 406 may be configured open (instead of a short or reactive loading). The separator 416 may include a tunable RF ground (e.g., ground tuning unit), which may include a filter circuit. The locations of the aperture tuning ports, antenna feed ports, ground contacts, and interface in FIGS. 4A, 4B, and 4C are intended for illustrative purposes and may not represent specific places and/or locations in a given electronic device.

Using a series of internal antenna feeds (e.g., antenna feed 462, antenna feed 464, antenna feed 466) and ground contacts (e.g., ground 442, ground 444, ground 446, ground 448), two separate radiation patterns (e.g., first antenna 450 and fourth antenna 454) can be established on the metal outer enclosure 420 above the first side split 432 and the second side split 436, and two separate radiation patterns (e.g., third antenna 452 and fifth antenna 456) can be established on the metal outer enclosure 420 below the first side split 432 and the second side split 436. In this way, antenna elements are formed on the metal outer enclosure 120 (FIG. 1). In one example, the upper enclosure portion 406 of the metal outer enclosure 420 is configured as a first antenna element for one or more antenna signals communicated through the antenna system and a shorting structure 417 in the upper enclosure portion 406 is configured to establish the first antenna element 450 separate from the fourth antenna element 454. The shorting structure may electrically couple a portion (e.g., a distal end) of an antenna element to the system ground to improve isolation between antenna elements (e.g., the first and fourth antenna elements). Examples of shorting structures include one or more of a pin, an electrical through hole, a contact pad, a wall (e.g., a shorting wall), a clip, a spring finger, a via, a Flex-on-Flex (FOF) connector, an internal grommet, or the like. The size and characteristics of the shorting structures can be selected to control antenna performance across different frequency bands. The shorting structure can also be designed to incorporate an antenna aperture port, which enables the operational state of the shorting structure to be dynamically switched between short, open, inductive, or capacitive modes, thereby improving performance across various wireless communication applications. The dynamic control of the shorting structure's status can be implemented using various reconfigurable RF components or switching mechanisms. Through shorting structures, separate multiple antenna portions around the camera bar 412 can be defined without utilization of visible, external, horizontal antenna splits on the back panel 440.

The first slot, the second slot, and the channel 480 may interconnect. In this way, the first side split 432 and the second side split 436 may connect with the bar split 422 to facilitate the separation of antenna elements. The first antenna 450 and the fourth antenna 454 are separated from the third antenna 452 and the fifth antenna 456 by the channel 480, the first side split 432, and the second side split 436. In various aspects, the first side split 432, the second side split 436, and the channel 480 effectively split the back panel 440 into two portions that are not in contact with one another, with some antennas on one side of the camera bar 412 and other antennas on another (e.g., opposite) side of the camera bar 412. The third antenna 452 may be separated from the fifth antenna 456 by grounding. For example, ground 444 located at the side frame 430, ground 442 located at the back panel 440, and the like, as illustrated in FIG. 4C. In some aspects, grounding may be utilized to separate the first antenna 450 and the fourth antenna 454.

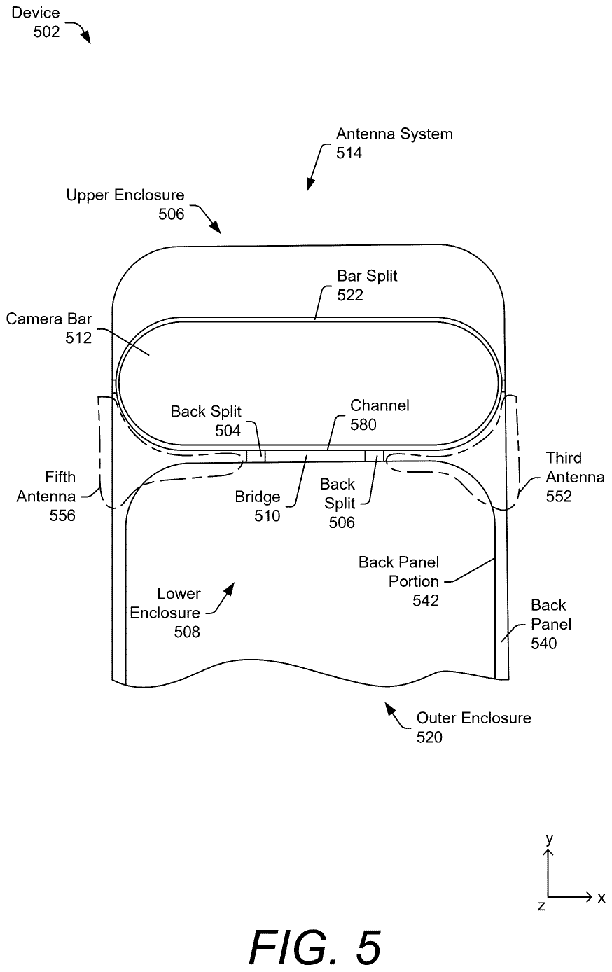

FIG. 5 is a partial rear view of an example implementation of an electronic device 502, which is similar to the electronic devices illustrated in FIG. 1-4C and described above, except as detailed below. Thus, the electronic device 502 includes an upper enclosure portion 506, a lower enclosure portion 508, a camera bar 512, an outer surface, an antenna system 514, an outer enclosure 520, a side frame, a first antenna split, a second antenna split, a back panel 540, a third antenna 552, a fifth antenna 556, wireless communication circuitry, and the like. In some aspects, the back cover (e.g., back panel 540) of the electronic device 502 does not include a separate covering or material, for example, the back cover does not include a glass covering (e.g., cover glass covering).

In the aspect illustrated in FIG. 5, the third antenna 552 is separated from the fifth antenna 556 by one or more back antenna splits defined in the back panel 540. For example, a back split 504 and/or a back split 506. The back antenna split(s) may extend to another back panel portion 542 of the back panel 540. For example, a portion 542 of the back panel 540 that includes Near Field Communication (NFC) hardware, wireless charging hardware, and the like. The lower enclosure portion 508 may include a metal segment (e.g., metal bridge portion 510) that extends between the back split 504 and the back split 506. The metal bridge portion 510 can be configured to be either shorted to the system ground or left un-shorted, based on desired antenna characteristics, which may provide design flexibility. In some aspects, a back antenna split is not present and the third antenna 552 and the fifth antenna 556 are electrically connected through the metal bridge portion 510.

### Continuous Uninterrupted Metal Enclosure

In some aspects, a system integrates antenna functionality within the continuous metal enclosure of an electronic device (e.g., electronic device 402), effectively managing wireless communication across various frequency bands while maintaining an aesthetically pleasing design. The device enclosure includes multiple metallic and non-metallic components that form an external housing of the device. The metallic segments of the enclosure, such as the back panel and the camera bar, are configured to achieve a substantially continuous metallic appearance.

A thin, non-metallic region, such as a thin polymer split, can be configured to electrically separate distinct metallic portions of the device enclosure without visually disrupting the overall metallic aesthetic. This non-metallic region can have a linear or curved form and may be positioned strategically to maintain the aesthetic continuity of the metallic enclosure. For example, a non-metallic region may be a thin strip of polymer material and can be overmolded into a machined channel within the metallic enclosure. The non-metallic region may be configured with a minimal thickness, for example, approximately 0.5 mm, to be visually unobtrusive and may be positioned at the base of the camera bar or along the side edges of the device. Side enclosure splits can be configured as linear non-metallic regions, which may be positioned along the side edges of the device enclosure. These splits can be oriented tangent to the camera bar, extending downwards along the sides of the device. Similar to the non-metallic region at the camera bar, these splits may include a thin polymer material, for example, with a width of approximately 1.3 mm. The form of these splits can be straight or slightly curved, following the contour of the device's side profile. They may be created by machining the metallic enclosure and overmolding a non-metallic material into the resulting gap. The primary components interact in a coordinated manner to achieve both an aesthetically continuous metallic enclosure and robust antenna functionality:

The camera bar may be configured to be substantially continuous with the main body (e.g., back panel) of the device enclosure, creating the appearance of a single, uninterrupted metallic surface from the top of the device to the rear camera area. This continuous appearance can be achieved by forming both the main body and the camera bar from a single block of material, such as by machining.

By integrating the antenna functionality with strategically placed, visually unobtrusive non-metallic regions within a substantially continuous metallic enclosure, the system can provide a device with enhanced aesthetic appeal (e.g., a seamless metallic appearance) while maintaining or improving radio frequency performance across diverse communication bands. This design approach can overcome limitations of prior solutions that often necessitate cosmetically visible polymer elements, which can compromise the visual integrity and perceived quality of a device.

In some aspects, the outer surfaces of the upper enclosure portion and the lower enclosure portion are co-planar, and the camera bar extends in a Z-direction away from the outer surfaces. In this way, the bar split can be visually hidden by the camera bar and its shadow, so that the small size of the bar split relative to the height of the camera bar can operate to substantially reduce the visual interpretation of seeing the bar split. Instead, visually the camera bar and outer surfaces of the metal back may visually appear as a single piece, uninterrupted by an antenna split line.

### Example Implementations and Configurations

The principles of the disclosed antenna systems for metal electronic device enclosures can accommodate various modifications and alternative configurations, each exhibiting distinct technical capabilities and operational advantages, primarily derived from the structural features and material compositions.

In one configuration, the apparatus can include a back panel and a camera bar, both formed from a metallic material. The back panel may define a substantial portion of the device's external housing. The camera bar, which may have an elongated or bar-like shape, can span a significant portion or the full width of the device. This configuration can allow for the creation of a substantially continuous metallic appearance from the top of the device to a rear camera area. This structural continuity can be achieved by machining both the back panel and the camera bar from a single block of metal material. Such a construction can provide enhanced structural integrity, potentially reducing component count and simplifying assembly processes compared to multi-part enclosures that may involve gluing or screwing separate components. This unified metallic structure can also contribute to improved durability.

Another configuration can involve the strategic incorporation of a non-metallic region, such as a thin polymer split. This non-metallic region can be configured to electrically separate distinct metallic portions of the device enclosure. For example, a thin polymer split may be positioned at the base of the camera bar, serving to electrically isolate the metallic camera bar from the metallic back panel. Similarly, side enclosure splits, also including a non-metallic material, can be positioned along the side edges of the device enclosure to electrically separate portions of a side metallic frame. This electrical separation may allow the metallic portions of the enclosure to function as distinct antenna elements or as part of an antenna radiating structure. Without such separation, the entire metallic enclosure might act as a single ground plane, which could significantly impede antenna performance. The thinness of these non-metallic regions (e.g., approximately 0.5 mm for the polymer split at the camera bar and 1.3 mm for the side enclosure splits) can enable them to be visually unobtrusive. This can allow the apparatus to achieve an aesthetic advantage of a seamless metallic appearance while simultaneously facilitating complex antenna functionality, addressing the challenge of maintaining both high-quality industrial design and effective wireless communication.

A further configuration of the apparatus can integrate various antenna elements (e.g., first antenna, third antenna, fourth antenna, fifth antenna) within the device enclosure, leveraging the electrically separated metallic portions as radiating structures. Internal antenna feeds can be configured to deliver radio frequency (RF) signals to specific points on these metallic elements, thereby causing them to radiate. Ground contacts, which may include a tunable RF ground, can provide a stable reference potential for the antenna elements. The tunable RF ground, implemented as an electrical contact from a circuit board with a filter circuit design, may be configured not to be an electrical short. This capability allows for controlled impedance matching and antenna tuning, which can improve the radiation efficiency and impedance bandwidth of the antenna elements across various frequency bands, which may help ensure effective wireless communication while mitigating potential interference or signal degradation. The placement of the antenna elements, feeds, and ground contacts, in conjunction with the strategic location of the non-metallic regions, can allow for the establishment of distinct radiation patterns for each antenna. For example, first antenna and fourth antenna may be configured for higher frequency bands (e.g., mid-band, high-band, ultra-high band), while third antenna and fifth antenna may be configured for lower frequency bands (e.g., low-band) or WLAN frequencies. This flexible antenna configuration can address the need for robust wireless connectivity across diverse communication standards (e.g., cellular, WLAN (Wi-Fi), global navigation satellite systems (GNSS)) within a compact device, overcoming the challenge of integrating multiple high-performance antennas into a design that prioritizes a continuous metallic aesthetic. Specific geometries of the metallic parts and dielectric materials, along with the design of internal feeds and grounding structures, can manage coupling between different antenna elements to maintain effective performance across various frequency bands.

In an implementation, a device enclosure can include a back panel formed from a metallic material and configured to define a substantial portion of an external housing of a device. A different configuration may include the back panel having a unibody structure or a multi-part assembly. For example, the back panel could be machined from a single block of metal material, or it could include multiple metallic segments joined together, potentially through welding, brazing, or a robust adhesive bond. It is contemplated that the size of the back panel can vary, suitable for applications beyond mobile phones, such as larger tablets, wearable devices, or even compact computing devices, each potentially requiring different internal volume configurations or external aesthetic considerations.

A different configuration may include a camera bar. A camera bar can be formed from a metallic material and integrated into the device enclosure. While an elongated or bar-like shape is contemplated, a different configuration may include a camera bar having a circular, square, or irregular shape, designed to encircle multiple camera lenses or sensors in a unique array. The camera bar can span a substantial portion or the full width of a device, or it may be a more localized feature. It is contemplated that the camera bar could be machined from the same block of material as the back panel to provide seamless material and color continuity, or from a different metallic material to provide a visual accent.

In an implementation, a non-metallic region, such as a thin polymer split, can be configured to electrically separate distinct metallic portions of the device enclosure. A different configuration may include this region having a linear or curved form, or a more complex geometric pattern, positioned strategically to maintain aesthetic continuity or to serve as a design element itself. For example, a non-metallic region may be a thin strip of polymer material, or it could be a ceramic, a glass composite, or a dielectric resin, offering different levels of durability, thermal properties, or visual transparency. It is contemplated that the non-metallic region could be overmolded into a machined channel within a metallic enclosure, or it could be a precisely cut insert that is bonded into place, potentially using an optically clear adhesive to maintain a transparent or translucent appearance. The non-metallic region may be configured with a minimal thickness, for example, approximately 0.5 mm, to be visually unobtrusive. In other aspects, the non-metallic region could have a greater thickness in certain areas to provide additional structural support or to define distinct visual segments. Its position can be at the base of the camera bar, along side edges of a device, or even within internal structures, to enable various antenna configurations or to manage electromagnetic interference.

Side enclosure splits can be configured as linear non-metallic regions, which may be positioned along side edges of a device enclosure. It is contemplated that these splits could be oriented tangent to the camera bar, extending downwards along the sides of a device, or they could follow a different contour of the device's side profile, such as a wave-like or zigzag pattern. Similar to the non-metallic region at the camera bar, these splits may include a thin polymer material, for example, with a width of approximately 1.3 mm, but a different configuration may include widths that vary along their length or are optimized for specific frequency bands. The form of these splits can be straight or slightly curved, or they could incorporate textured surfaces or embedded aesthetic elements, such as metallic flakes or color-shifting pigments, to enhance visual appeal. They may be created by machining a metallic enclosure and overmolding a dielectric material into the resulting gap, or they could be formed by a co-molding process where the metallic and non-metallic materials are combined during a single manufacturing step. These side enclosure splits can also serve as attachment points for accessories or external modules, enhancing the versatility of a device.

### EXAMPLES

In the following section, examples of antenna systems for metal electronic device enclosures are provided.

Example 1. An antenna system for an electronic device comprising: a metal outer enclosure comprising: a back panel defining a back cover of the metal outer enclosure; a side frame that extends about a periphery of the back panel, the side frame includes a first side frame portion opposite a second side frame portion and a top end frame portion that extends between the first side frame portion and the second side frame portion; a first antenna split defined in a first side slot defined through the first side frame portion, which electrically isolates the first side frame portion from the top end frame portion; and a second antenna split defined in a second side slot defined through the second side frame portion, which electrically isolates the top end frame portion from the second side frame portion; and a bar split defined in a channel defined through the back panel, the channel extending between the first side slot and the second side slot to define an upper enclosure portion separate from a lower enclosure portion, the bar split extending between the first antenna split and the second antenna split.

Example 2. The antenna system of Example 1, wherein the upper enclosure portion is configured as a first antenna element for one or more antenna signals communicated through the antenna system.

Example 3. The antenna system of Example 2, wherein the upper enclosure portion is further configured as a fourth antenna element for one or more antenna signals communicated through the antenna system, and the upper enclosure portion further comprises a shorting structure configured to establish the first antenna element separate from the fourth antenna element.

Example 4. The antenna system of Example 3, wherein the shorting structure comprises at least one of: a shorting wall; an aperture port; or an internal grommet.

Example 5. The antenna system of Example 4, wherein the shorting structure is configured to selectively short or un-short a portion of the upper enclosure portion to a system ground, thereby altering the antenna's electrical characteristics.

Example 6. The antenna system of Example 3, wherein the shorting structure is configured to be dynamically switched between at least two operational modes selected from: a short mode; an open mode; an inductive mode; or a capacitive mode.

Example 7. The antenna system of Example 1, further comprising at least one antenna feed configured to excite at least one of the upper enclosure portion or the lower enclosure portion to function as an antenna element.

Example 8. The antenna system of Example 1, further comprising at least one ground contact configured to electrically couple at least one of the upper enclosure portion or the lower enclosure portion to a system ground.

Example 9. The antenna system of Example 1, wherein the first antenna split, the second antenna split, and the bar split that surrounds the camera bar comprise a non-conductive material.

Example 10. The antenna system of Example 1, wherein the lower enclosure portion is configured as a third antenna element for one or more antenna signals generated by the antenna system.

Example 11. The antenna system of Example 10, wherein the lower enclosure portion further comprises: at least one back antenna split that extends from the bar split, the back antenna split configured to establish a fifth antenna element separate from the third antenna element.

Example 12. The antenna system of Example 1, further comprising: wireless communication circuitry configured to generate and receive the one or more antenna signals.

Example 13. The antenna system of Example 12, wherein the wireless communication circuitry is configured to tune an antenna to one of a plurality of frequency bands.

Example 14. The antenna system of Example 1, wherein the first antenna split, the second antenna split, and the bar antenna split are configured to mechanically combine adjacent antenna portions through a Nano Molding Technology (NMT) process.

Example 15. The antenna system of Example 1, wherein: the channel is a ring-shaped channel, a metal camera bar extending from the ring-shaped channel, and the camera bar is electrically isolated from the upper enclosure portion and the lower enclosure portion by one or more of the first side slot, the second side slot, or the ring-shaped channel.

Example 16. A metal outer enclosure for an electronic device, the metal outer enclosure comprising: a back panel defining a back cover of the metal outer enclosure; a side frame that extends about a periphery of the back panel, the side frame includes a first side frame portion opposite a second side frame portion and a top end frame portion that extends between the first side frame portion and the second side frame portion; a first side slot defined through the first side frame portion; a second side slot defined through the second side frame portion; a channel defined through the back panel, the channel extending between the first side slot and the second side slot to define an upper enclosure portion separate from a lower enclosure portion; and a camera bar defined within the channel, the camera bar surrounded by the channel, where the upper enclosure portion, the camera bar, and the lower enclosure portion are electrically isolated from one another by the first side slot, the second side slot, and the channel.

Example 17. The metal outer enclosure of Example 16, wherein at least one of the first side slot, the second side slot, or the channel includes an antenna split formed of at least one of: a polymer material; non-conductive material; or a Nano Molding Technology (NMT) material.

Example 18. The metal outer enclosure of Example 16, wherein the upper enclosure portion, the camera bar, and the lower enclosure portion are formed from the same piece of metal material.

Example 19. The metal outer enclosure of Example 16, wherein, to electrically isolate the upper enclosure portion from the lower enclosure portion, a first antenna split is defined in the first side slot between the upper enclosure portion and the lower enclosure portion and wherein a second antenna split is defined in the second side slot between the upper enclosure portion and the lower enclosure portion.

Example 20. The metal outer enclosure of Example 16, wherein an outer surface of the upper enclosure portion and an outer surface of the lower enclosure portion are co-planar and wherein the camera bar extends in a Z-direction away from the outer surfaces of the upper enclosure portion and the lower enclosure portion.

Example 21. The metal outer enclosure of Example 16, wherein the upper enclosure portion is configured to function as a first antenna element and a fourth antenna element, and wherein the lower enclosure portion is configured to function as a third antenna element and a fifth antenna element.

Example 22. The metal outer enclosure of example 16, wherein the channel is a ring-shaped channel.

Example 23. A metal outer enclosure for an electronic device, the metal outer enclosure comprising: a back panel defining a back cover of the metal outer enclosure; a side frame that extends about a periphery of the back panel, the side frame including a first side frame portion, a second side frame portion, and a top end frame portion; a first side slot defined through the side frame, the first side slot configured to electrically isolate the first side frame portion from the top end frame portion; a second side slot defined through the side frame, the second side slot configured to electrically isolate the second side frame portion from the top end frame portion; and a camera bar defined in the back panel, the camera bar surrounded by a channel defined through the back panel, the channel configured to extend between the first side slot and the second side slot.

Example 24. The metal outer enclosure of Example 23, wherein the back cover lacks a cover glass covering.

Example 25. The metal outer enclosure of Example 23, wherein the channel is ring-shaped.

Example 26. The metal outer enclosure of Example 24, wherein the camera bar extends across a substantial portion of a width of the back panel.

Example 27. The metal outer enclosure of Example 24, where at least one of the first side slot, the second side slot, or the ring-shaped channel includes an antenna split formed of at least one of: a polymer material; a non-conductive material; or a Nano Molding Technology (NMT) material.

Example 28. The metal outer enclosure of Example 24, wherein the channel defines a first back panel portion on a first side of the camera bar and a second back panel portion on a second side of the camera bar.

Example 29. The metal outer enclosure of Example 28, wherein the first back panel portion and the second side frame portion form an upper enclosure portion, and wherein the upper enclosure portion is configured to function as a first antenna element and a fourth antenna element.

Example 30. The metal outer enclosure of Example 29, wherein the second back panel portion, the first side frame portion, and the second side frame portion form a lower enclosure portion, and wherein the lower enclosure portion is configured to function as a third antenna element and a fifth antenna element.

Example 31. The metal outer enclosure of Example 28, wherein the first back panel portion and the second side frame portion form an upper enclosure portion, wherein the second back panel portion, the first side frame portion, and the second side frame portion form a lower enclosure portion, and wherein the upper enclosure portion, the camera bar, and the lower enclosure portion are formed from a single piece of metal material.

Example 32. The metal outer enclosure of Example 28, wherein the first back panel portion and the second side frame portion form an upper enclosure portion, wherein the second back panel portion, the first side frame portion, and the second side frame portion form a lower enclosure portion, wherein the first side slot is defined between the upper enclosure portion and the lower enclosure portion, and wherein the second side slot is defined between the upper enclosure portion and the lower enclosure portion to electrically isolate the upper enclosure portion from the lower enclosure portion.

Example 33. The metal outer enclosure of Example 28, wherein the first back panel portion and the second side frame portion form an upper enclosure portion, wherein the second back panel portion, the first side frame portion, and the second side frame portion form a lower enclosure portion, and wherein outer surfaces of the upper enclosure portion and the lower enclosure portion are co-planar.

Example 34. The metal outer enclosure of Example 33, where the camera bar extends in a Z-direction away from the outer surfaces of the upper enclosure portion and the lower enclosure portion.

Example 35. The metal outer enclosure of Example 28, wherein at least one of: the first back panel portion and the second side frame portion form an upper enclosure portion, the upper enclosure portion is configured to function as a first antenna element and a fourth antenna element; or the second back panel portion, the first side frame portion, and the second side frame portion form a lower enclosure portion, the lower enclosure portion is configured to function as a third antenna element and a fifth antenna element.

### Construction

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

### Conclusion

Although implementations of antenna systems for metal electronic device enclosures have been described in language specific to features and/or methods, it is to be understood that the subject of the appended claims is not necessarily limited to the specific features or methods described. Rather, the specific features and methods are disclosed as example implementations of devices and systems related to antenna systems for metal electronic device enclosures.

The disclosed antenna systems for metal electronic device enclosures integrate multiple antennas within metal electronic device enclosures by strategically utilizing a mechanically floated camera bar and segmented portions of the back panel. This approach aims to circumvent the performance and aesthetic limitations often associated with visible antenna splits in conventional designs. By leveraging the existing metal structure and introducing specialized shorting mechanisms, the antenna systems for metal electronic device enclosures can enhance antenna performance while facilitating a seamless, fully metal device form factor.

What is claimed is:

1. An antenna system for an electronic device comprising:
a metal outer enclosure comprising:
a back panel defining a back cover of the metal outer enclosure;
a side frame that extends about a periphery of the back panel, the side frame includes a first side frame portion opposite a second side frame portion and a top end frame portion that extends between the first side frame portion and the second side frame portion;
a first antenna split defined in a first side slot defined through the first side frame portion, which electrically isolates the first side frame portion from the top end frame portion; and
a second antenna split defined in a second side slot defined through the second side frame portion, which electrically isolates the top end frame portion from the second side frame portion; and
a bar antenna split defined in a channel defined through the back panel, the channel extending between the first side slot and the second side slot to define an upper enclosure portion separate from a lower enclosure portion, the bar antenna split extending between the first antenna split and the second antenna split.

2. The antenna system of claim 1, wherein the upper enclosure portion is configured as a first antenna element for one or more antenna signals communicated through the antenna system.

3. The antenna system of claim 2, wherein the upper enclosure portion is further configured as a fourth antenna element for one or more antenna signals communicated through the antenna system, and the upper enclosure portion further comprises a shorting structure configured to establish the first antenna element separate from the fourth antenna element.

4. The antenna system of claim 3, wherein the shorting structure comprises at least one of:
a shorting wall;
an aperture port; or
an internal grommet.

5. The antenna system of claim 4, wherein the shorting structure is configured to selectively short or un-short a portion of the upper enclosure portion to a system ground, thereby altering the antenna's electrical characteristics.

6. The antenna system of claim 3, wherein the shorting structure is configured to be dynamically switched between at least two operational modes selected from:
a short mode;
an open mode;
an inductive mode; or
a capacitive mode.

7. The antenna system of claim 1, further comprising at least one antenna feed configured to excite at least one of the upper enclosure portion or the lower enclosure portion to function as an antenna element.

8. The antenna system of claim 1, further comprising at least one ground contact configured to electrically couple at least one of the upper enclosure portion or the lower enclosure portion to a system ground.

9. The antenna system of claim 1, wherein the first antenna split, the second antenna split, and the bar antenna split comprise a non-conductive material.

10. The antenna system of claim 1, wherein the lower enclosure portion is configured as a third antenna element for one or more antenna signals generated by the antenna system.

11. The antenna system of claim 10, wherein the lower enclosure portion further comprises:
at least one back antenna split that extends from the bar antenna split, the back antenna split configured to establish a fifth antenna element separate from the third antenna element.

12. The antenna system of claim 1, further comprising:
wireless communication circuitry configured to generate and receive the one or more antenna signals.

13. The antenna system of claim 12, wherein the wireless communication circuitry is configured to tune an antenna to one of a plurality of frequency bands.

14. The antenna system of claim 1, wherein the first antenna split, the second antenna split, and the bar antenna split are configured to mechanically combine adjacent antenna portions through a Nano Molding Technology (NMT) process.

15. The antenna system of claim 1, wherein:
the channel is a ring-shaped channel,
a metal camera bar extending from the ring-shaped channel, and
the metal camera bar is electrically isolated from the upper enclosure portion and the lower enclosure portion by one or more of the first side slot, the second side slot, or the ring-shaped channel.
